(19) United States
(12) Patent Application Publication
(10) Pub. No.: US 2006/0236350 A1
(43) Pub. Date: Oct. 19, 2006

(54) Distribution of a broadcast program

(76) Inventors: Robert Fifield, Redhill (GB); David H. Evans, Crawley (GB)

Correspondence Address: PHILIPS INTELLECTUAL PROPERTY & STANDARDS, P.O. BOX 3001, BRIARCLIFF MANOR, NY, 10510, US

(21) Appl. No.: 10/538,565

(22) PCT Filed: Dec. 3, 2003
(86) PCT No.: PCT/IB03/05644

§ 371 Date: Jun. 15, 2005

(30) Foreign Application Priority Data
Dec. 17, 2002 (GB) 0229318.1

(51) Int. Cl. H04N 7/18

(52) U.S. Cl. 725/81

(57) ABSTRACT

A system for wireless distribution of a broadcast program within a building comprises a distribution apparatus (110) for transmitting the program and at least one program receiving apparatus (160) for receiving the broadcast program. The program receiving apparatus may receive the broadcast program from a neighbouring distribution apparatus (210) when the distribution capacity of the home distribution apparatus is fully loaded with other programs. A program receiving apparatus receiving from a neighbouring distribution apparatus may discontinue that reception when the broadcast program can be made available from its home distribution apparatus, or when the distribution capacity is required for a neighbouring program receiving apparatus for a different program.

The invention relates to a wireless system for distributing a broadcast program around a building, a method of operating such a system, and to apparatuses for use in such a system.

Wireless protocols, for example IEEE 802.11a and HIPERLAN 2, can be used for distributing broadcast programs around a building. A broadcast signal is received off-air or via a cable by a distribution equipment, decoded if necessary, and individual programs distributed by means of a wireless protocol to a receiving equipment. For example, a television program may be received by a domestic distribution equipment via a roof-top antenna and distributed to domestic television receivers in a home. Such a distribution equipment may be equipped to transmit more than one program simultaneously, thereby enabling different televisions, or other receiving equipments, to receive different programs.

One technological development that is likely to fuel an increase in the use of wireless distribution equipment is the introduction of digital television channels, whereby a distribution equipment will receive a digitally encoded signal from a broadcast source and transmit programs via low-cost wireless network devices to legacy analogue television receivers.

There is a limited amount of spectrum available for use by wireless distribution equipment, and as usage of such equipment increases, the quality of transmission can be degraded due to interference between different systems, and the use of such equipment can be compromised due to lack of sufficient spectrum in which to transmit all the desired programs. These problems will be particularly apparent for high bit rate services for example digital television, in densely populated areas, and at peak television viewing times.

An object of the invention is to increase the utility of wireless systems for distributing a broadcast program around a building. The increased utility may result from reduced spectrum usage or from an increase in the number of programs which may be received simultaneously within the building.

According to one aspect of the invention there is provided a wireless system for distributing a broadcast program around a building, comprising a distribution apparatus, at least one program receiving apparatus and means for associating the at least one program receiving apparatus with the distribution apparatus, wherein the distribution apparatus comprises a receiver for receiving a broadcast program from a broadcasting source and a wireless transmitter for transmitting the received broadcast program, and wherein the program receiving apparatus comprises an interface for receiving an indication of a broadcast program to be received by the program receiving apparatus, a wireless receiver for receiving the indicated broadcast program and an adaptation means for adapting the program receiving apparatus to receive the indicated broadcast program from the associated distribution apparatus if the associated distribution apparatus has sufficient available transmission capacity to transmit the indicated broadcast program and otherwise adapting the program receiving apparatus to search for a non-associated distribution apparatus having available transmission capacity to transmit the indicated broadcast program.

According to a second aspect of the invention there is provided a method of operating a wireless system for distributing a broadcast program around a building, the system comprising a distribution apparatus, at least one program receiving apparatus and means for associating the at least one program receiving apparatus with the distribution apparatus, the method comprising at the program receiving apparatus: receiving an indication of a broadcast program to be received by the program receiving apparatus; and adapting the program receiving apparatus to receive the indicated broadcast program from the associated distribution apparatus if the distribution apparatus has available capacity for transmitting the indicated broadcast program, otherwise adapting the program receiving apparatus to receive the indicated broadcast program from a non-associated distribution apparatus.

According to a third aspect of the invention there is provided a wireless distribution apparatus for distributing a broadcast program around a building to an associated program receiving apparatus, comprising means for receiving a request to transmit an indicated broadcast program, means responsive to the received request for determining whether a current transmitted broadcast program is being transmitted to an associated program receiving apparatus, and means responsive to determining that the current transmitted broadcast program is being transmitted to no associated program receiving apparatus for replacing the current transmitted broadcast program by the indicated broadcast program.

According to a fourth aspect of the invention there is provided a program receiving apparatus for receiving a broadcast program distributed around a building by an associated wireless distribution apparatus, comprising an interface for receiving an indication of a broadcast program to be received by the program receiving apparatus, a wireless receiver for receiving the indicated broadcast program, and an adaptation means for adapting the program receiving apparatus to receive the indicated broadcast program from the associated distribution apparatus if the associated distribution apparatus has sufficient available transmission capacity to transmit the indicated broadcast program and otherwise adapting the program receiving apparatus to search for a non-associated distribution apparatus having available transmission capacity to transmit the indicated broadcast program.

The invention is based on the realisation that, at peak viewing times, a large proportion of television viewing households will be watching the same program. Therefore, a large proportion of distribution apparatuses will be transmitting the same program. The number of signals being transmitted can be reduced if neighbouring households can share a common signal, thereby reducing the probability of interference. If the distribution capacity of one distribution apparatus is fully loaded, an apparent increase in capacity can be achieved by receiving an additional program from a neighbouring distribution apparatus.

Although the invention was conceived in the context of the distribution of television programs, the principles can also be applied to the distribution of other types of broadcast program, including data and audio, and other types of receiving equipment, for example a Personal Computer (PC) or a Personal Digital Assistant (PDA).

The invention will now be described, by way of example only, with reference to the accompanying drawings wherein:

FIG. 1 is a block schematic diagram of two wireless systems for distributing broadcast programs around respective buildings,

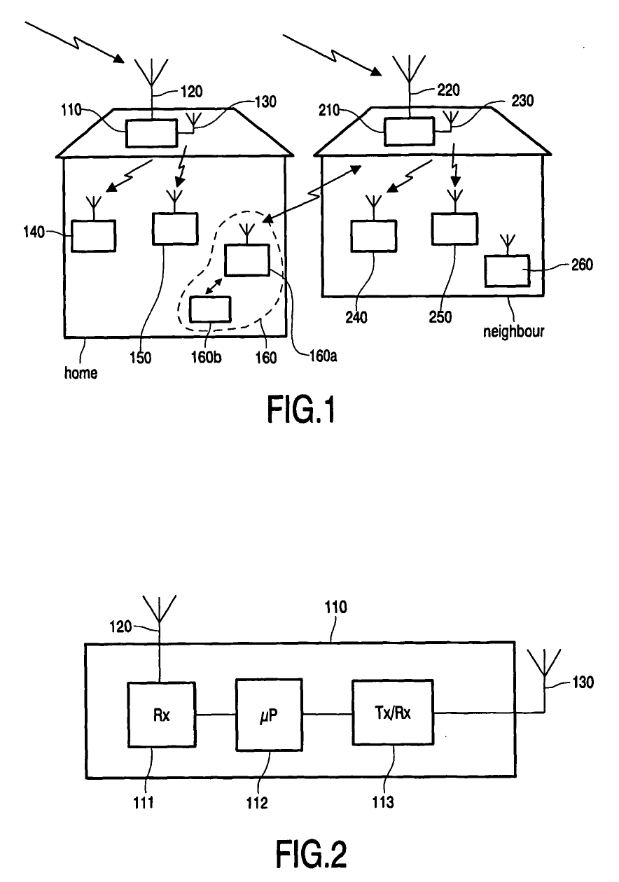

FIG. 2 is a block schematic diagram of a distribution apparatus,

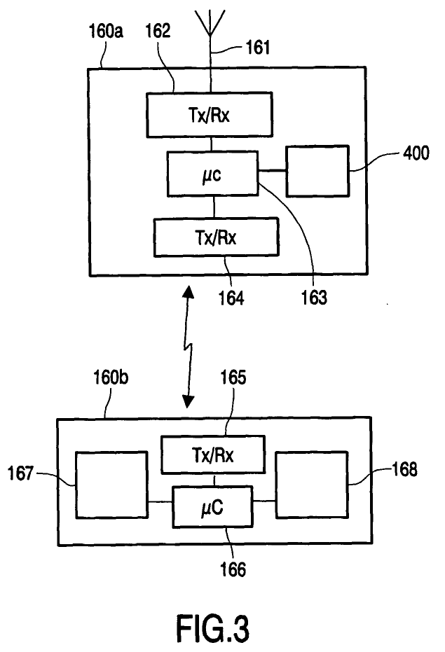

FIG. 3 is a block schematic diagram of a program receiving apparatus, and

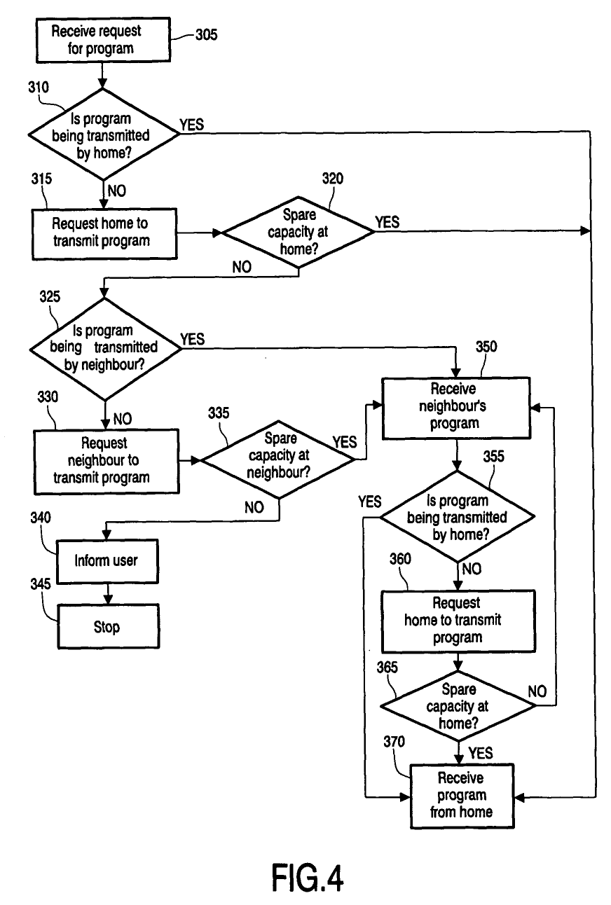

FIG. 4 is a flow chart of a method of operating a wireless system for distributing a broadcast program around a building.

Referring to FIG. 1, there is illustrated two wireless systems for distributing a broadcast program around their respective buildings, for convenience of description referred to as “home” and “neighbour”. The home wireless system, installed in the “home” building comprises a distribution apparatus 110 coupled to a first antenna 120 for receiving a broadcast signal from a broadcast source and coupled to a second antenna 130 for transmitting one or more programs to first, second and third program receiving apparatuses, 140 150, and 160. The first and second program receiving apparatuses 140, 150 are illustrated as unitary apparatuses, and the third program receiving apparatus 160 is illustrated as a non-unitary apparatus, having a main device 160a and a user interface device 160b implemented as separate physical units, as will be described in more detail below. The first and second program receiving apparatuses 140, 150 have integral user interfaces.

The neighbour wireless system installed in the “neighbour” building comprises a distribution apparatus 210 coupled to a first antenna 220 for receiving a broadcast signal from a broadcast source and coupled to a second antenna 230 for transmitting one or more programs to first, second and third program receiving apparatuses, 240, 250 and 260 respectively.

Communication between the distribution apparatus 110 and 210 and their associated program receiving apparatuses is by means of a short range wireless protocol, for example IEEE 802.11.a or HIPERLAN 2. Although such communication has a short range, being intended primarily for communication within the respective buildings, the communication signals within one building can to some extent be received within the other building.

Association between a distribution apparatus and its program receiving apparatuses may be made in various ways. For example, the two wireless systems may use different frequencies, different codes or different addresses for distributing programs. In these examples, associated apparatuses use common frequencies, common codes or common addresses respectively, and non-associated apparatuses use different frequencies, different codes or different addresses respectively.

Referring to FIG. 2, the distribution apparatus 110 comprises a receiver 111 for receiving a broadcast signal via the first antenna 120. The receiver 111 is coupled to a processing means 112 for extracting a program from the received broadcast signal. The processing means 112 is coupled to a wireless transceiver 113 and delivers the program to the transceiver 113 for transmission of the program to one or more program receiving apparatus 140, 150, 160 via the second antenna 130, using a short range wireless protocol. The processing means 112 is also used for processing control signals passing between the distribution apparatus 110 and the program receiving apparatuses 140, 150, 160.

Referring to FIG. 3, the program receiving apparatus main device 160a comprises a transceiver 162 for receiving, via an antenna 161, a program transmitted by the distribution apparatus 110 and for the communication of control signals between the distribution apparatus 110 and the main unit 160a of the program receiving apparatus 160. The transceiver 162 is coupled to a processing means 163 for processing the received program for delivery to an integral program output device 400. The form of the program output device 400 depends on the particular application. For example, the program output device could be a PDA, a PC, an audio player, a monitor screen or a television set. Optionally, the program receiving apparatus 160a/160b may not include the program output device 400 integrally, this being coupled as a non-integral unit.

The processing means 163 is coupled to a further transceiver 164 for the communication of control signals between the main device 160a and the user interface device 160b. This communication uses a short range wireless protocol for example Zigbee or Bluetooth (Registered Trade Marks).

The user interface device 160b comprises a processing means 166 coupled to a transceiver 165 for the communication of control signals between Is the user interface device 160b and the main device 160a, to an input device 167 whereby a user may indicate which program is to be delivered to the program output device 400, and a display device 168 for displaying status information to the user. The form of the user interface device 160b depends on the particular application. For example, the user interface device 160b may take the physical form of a television remote controller. Optionally, all or part of the user interface may be provided integrally with the main part 160a. As a further alternative, all or part of the user interface may be omitted from the program receiving apparatus 160, instead being provided by a non-integral program output device 400. As yet a further option, which ever device supports the user interface may communicate directly with the distribution apparatus 110, rather than via the main device 160a, for the purpose of determining which program will be transmitted by the distribution apparatus 110.

Referring to the flow chart of FIG. 4, the operation of the home wireless system is as follows. At step 305 an indication is received from a user, via the user interface device 160b, indicating a particular program to be delivered to the program output device 400. This request is communicated to the main device 160a via the transceivers 164, 165. At step 310 the processing means 163 checks whether the indicated program is currently being transmitted by the distribution apparatus 110 and received by the transceiver 162. If the indicated program is currently being transmitted by the distribution apparatus 110, flow proceeds to step 370 in which the indicated program is received by the transceiver 162 and delivered to the output device 400. If the indicated program is not currently being transmitted by the distribution apparatus 110, flow proceeds to step 315 in which the processing means 163 initiates transmission by the program receiving apparatus 160 of a request to the distribution apparatus 110 to transmit of the indicated program; flow then proceeds to step 320.

At step 320, in response to the request for transmission of the indicated program, the processing means 112 determines whether the distribution apparatus 110 has sufficient transmission capacity available to transmit the indicated program. If sufficient capacity is available, the processing means 112 initiates transmission of the indicated program by the distribution apparatus 110 and flow proceeds to step 370 in which the indicated program is received by the transceiver 162 and delivered to the output device 400. If sufficient capacity is not available, the non-availability is reported back to the program receiving apparatus 160 and flow proceeds to step 325.

At step 325, in response to the non-availability report, the processing means 163 checks whether the indicated program is currently being transmitted by the neighbour distribution apparatus 210 and received by the transceiver 162. If the indicated program is currently being transmitted by the neighbour distribution apparatus 210, flow proceeds to step 350 in which the indicated program is received by the transceiver 162 and delivered to the output device 400. If the indicated program is not currently being transmitted by the neighbour distribution apparatus 210, flow proceeds to step 330 in which the processing means 163 initiates transmission by the program receiving apparatus 160 of a request to the neighbour distribution apparatus 210 to transmit the indicated program; flow then proceeds to step 335.

At step 335, in response to the request for transmission of the indicated program, the neighbour distribution apparatus 210 determines whether it has sufficient transmission capacity available to transmit the indicated program. If sufficient capacity is available, the neighbour distribution apparatus 210 commences transmission of the indicated program and flow proceeds to step 350 in which the indicated program is received by the transceiver 162 and delivered to the output device 400. If sufficient capacity is not available, the non-availability is reported back to the program receiving apparatus 160 and flow proceeds to step 340 in which the user is informed of the non-availability by means of the user interface device 160b, and the process then stops at step 345.

At step 350, while receiving the indicated program from the neighbour distribution apparatus 210, the program receiving apparatus 160 intermittently determines whether the supply of the indicated program can be transferred to the home distribution apparatus 110, as follows. At step 355 the processing means 163 checks whether the indicated program is currently being transmitted by the home distribution apparatus 110. This may be the case if, for example, another of the program receiving apparatus 140 or 150 has switched from receiving another program to receiving the indicated program. If the indicated program is currently being transmitted by the home distribution apparatus 110, flow proceeds to step 370 in which the indicated program is received by the transceiver 162 from the home distribution apparatus 110 and delivered to the output device 400. If the indicated program is not currently being transmitted by the home distribution apparatus 110, flow proceeds to step 360 in which the program receiving apparatus 160 communicates with the home distribution apparatus 110 to request transmission of the indicated program; flow then proceeds to step 365.

At step 365, in response to the request for transmission of the indicated program, the processing means 112 determines whether the home distribution apparatus 110 has sufficient transmission capacity available to transmit the indicated program. If sufficient capacity is available, the processing means 112 initiates transmission of the indicated program by the home distribution apparatus 110 and flow proceeds to step 370 in which the indicated program is received by the transceiver 162 from the home distribution apparatus 110 and delivered to the output device 400; optionally the program receiving apparatus may report to the neighbour distribution apparatus 210 that it no longer will be receiving the indicated program from that distribution apparatus. If sufficient transmission capacity is not available at the home distribution apparatus 110, the non-availability is reported back to the program receiving apparatus 160 and flow proceeds to step 350 in which the program receiving apparatus 160 continues to receive the indicated program from the neighbour distribution apparatus 210.

Although an embodiment has been described in which a program receiving apparatus 160 associated with the home distribution apparatus 110 receives a program from the neighbour distribution apparatus 210, a neighbour program receiving apparatus 240, 250, or 260 may also receive a program transmitted by the home distribution apparatus 110, either when the home distribution apparatus 110 is transmitting a particular program to a home program receiving apparatus 140, 150 or 160, or when a neighbour program receiving apparatus 240, 250, or 260 requests the home distribution apparatus 110 to transmitted a particular program and the home distribution apparatus 110 has sufficient available transmission capacity to comply with the request.

Optionally, the steps 330 and 335 of FIG. 4 may be omitted, such that the program receiving apparatus 160 receives the indicated program from the neighbour distribution apparatus 210 only if that program is currently transmitted, and does not request transmission if that program is not currently being transmitted. In this case flow proceeds directly to step 340 instead of steps 330 and 335.

The embodiments described above in relation to FIG. 4 can increase the number of programs which may be received simultaneously within a building by employing the resources of a neighbour distribution apparatus.

In another embodiment of the invention, if the indicated program is not currently being transmitted by the home distribution apparatus 110, the processing means 163 checks whether the indicated program can currently be received from the neighbour distribution apparatus 210 by the program receiving apparatus 160, before requesting the home distribution apparatus to transmit the indicated program. This corresponds to performing step 325 of FIG. 4 before step 315 instead of after. This embodiment can reduce spectrum usage by avoiding duplicate transmissions of a program.

Optionally, the broadcast signal may be received by a distribution apparatus 110, 210 off-air or via a cable.

Optionally, the distribution apparatus 110, 210 may be equipped to transmit one or a plurality of programs simultaneously.

Optionally, steps additional to those described above in relation to FIG. 4 may be included. For example, the processing means 112 of the distribution apparatus 110 may maintain a record of which program receiving apparatuses are currently receiving a program transmitted by it, and whether each of these program receiving apparatuses are home i.e. associated, or neighbour i.e. non-associated, apparatuses. As another example, prioritisation may be applied; the distribution apparatus 110 may discontinue transmitting a program for the benefit of only a non-associated program receiving apparatus if the transmission capacity is required for the benefit of an associated program receiving apparatus; the distribution apparatus 110 may refuse to comply with a request from a non-associated program receiving apparatus even if it currently has transmission capacity available, in order to reserve the available transmission capacity for serving associated program receiving apparatuses.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the art of wireless systems and the art of program distribution and which may be used instead of or in addition to features already described herein.

1. A wireless system for distributing a broadcast program around a building, comprising a distribution apparatus (110), at least one program receiving apparatus (160) and means (113, 162) for associating the at least one program receiving apparatus with the distribution apparatus, wherein the distribution apparatus comprises a receiver (111) for receiving a broadcast program from a broadcasting source and a wireless transmitter (113) for transmitting the received broadcast program, and wherein the program receiving apparatus comprises an interface (160b) for receiving an indication of a broadcast program to be received by the program receiving apparatus, a wireless receiver (162) for receiving the indicated broadcast program and an adaptation means (163) for adapting the program receiving apparatus to receive the indicated broadcast program from the associated distribution apparatus if the associated distribution apparatus has sufficient available transmission capacity to transmit the indicated broadcast program and otherwise adapting the program receiving apparatus to search for a non-associated distribution apparatus having available transmission capacity to transmit the indicated broadcast program.

2. A wireless system as claimed in claim 1, wherein the adaptation means (163) for adapting the program receiving apparatus to receive the indicated broadcast program from the associated distribution apparatus comprises means (163) for adapting the program receiving apparatus to receive a current transmission of the indicated broadcast program from the associated distribution apparatus.

3. A wireless system as claimed in claim 1, wherein the adaptation means (163) for adapting the program receiving apparatus to receive the indicated broadcast program from the associated distribution apparatus comprises means (163, 162) for transmitting a request to the associated distribution apparatus for transmission of the indicated broadcast program, and wherein the associated distribution apparatus further comprises means (112, 113) responsive to the request for transmitting the indicated broadcast program if transmission capacity is available.

4. A wireless system as claimed in claim 3, wherein the means (112, 113) responsive to the request for transmitting the indicated broadcast program if transmission capacity is available further comprises
means (112) for determining whether a current transmitted broadcast program is being transmitted to an associated program receiving apparatus and
means (112) responsive to determining that the current transmitted broadcast program is being transmitted to no associated program receiving apparatus for replacing the current transmitted broadcast program by the indicated broadcast program.

5. A wireless system as claimed in claim 1, wherein the means (162, 163) for adapting the program receiving apparatus to search for a non-associated distribution apparatus having available transmission capacity to transmit the indicated broadcast program comprises means (162, 163) for searching for a non-associated distribution apparatus currently transmitting the indicated broadcast program.

6. A wireless system as claimed in claims 1, wherein the means (162, 163) for adapting the program receiving apparatus to search for a non-associated distribution apparatus having available transmission capacity to transmit the indicated broadcast program comprises means (162, 163) for requesting a non-associated distribution apparatus to transmit the indicated broadcast program.

7. A wireless system as claimed in claim 1, wherein the program receiving apparatus further comprises means (162, 163) for, when receiving the indicated program from a non-associated distribution apparatus, intermittently checking the availability of transmission capacity of the associated distribution apparatus for transmitting the indicated program, and wherein the adaptation of the program receiving apparatus to receive the indicated broadcast program from the associated distribution apparatus is responsive to such capacity being available.

8. A method of operating a wireless system for distributing a broadcast program around a building and comprising a distribution apparatus (110), at least one program receiving apparatus (160) and means (113, 162) for associating the at least one program receiving apparatus with the distribution apparatus, the method comprising at the program receiving apparatus:
receiving (160b) an indication of a broadcast program to be received by the program receiving apparatus; and adapting (162, 163) the program receiving apparatus to receive the indicated broadcast program from the associated distribution apparatus if the distribution apparatus has available capacity for transmitting the indicated broadcast program, otherwise adapting (162, 163) the program receiving apparatus to receive the indicated broadcast program from a non-associated distribution apparatus.

9. A method as claimed in claim 8, wherein adapting the program receiving apparatus to receive the indicated broadcast program from the associated distribution apparatus comprises receiving (162) a current transmission of the indicated broadcast program from the associated distribution apparatus.

10. A method as claimed in claim 8, wherein adapting the program receiving apparatus to receive the indicated broadcast program from the associated distribution apparatus comprises transmitting (162) the request requesting transmission of the indicated broadcast program, and at the distribution apparatus: receiving (113) the request; and determining (112) whether the distribution apparatus has available capacity for transmitting the indicated broadcast program, and if the distribution apparatus has available capacity for transmitting the indicated broadcast program, receiving (111) and transmitting (112) the indicated broadcast program.

11. A method as claimed in claim 10, wherein determining whether the distribution apparatus has available capacity for transmitting the indicated program comprises determining (112) whether a currently transmitted broadcast program is being transmitted to any associated program receiving apparatus and, in response to determining that a currently transmitted broadcast program is being transmitted to no associated program receiving apparatus, replacing (112, 113) the currently transmitted broadcast program by the indicated broadcast program.

12. A method as claimed in claim 8, wherein adapting the program receiving apparatus to receive the indicated broadcast program from a non-associated distribution apparatus comprises receiving (162) a current transmission of the indicated broadcast program from the non-associated distribution apparatus.

13. A method as claimed in claims 8, wherein adapting the program receiving apparatus to receive the indicated broadcast program from a non-associated distribution apparatus comprises transmitting (162, 163) a request for the non-associated distribution apparatus to transmit the indicated broadcast program.

14. A method as claimed in claim 8, comprising at the program reception apparatus discontinuing reception (162) of the indicated broadcast program from the non-associated distribution apparatus and commencing reception (162) of the indicated broadcast program from the associated distribution apparatus, in response to capacity for transmitting the indicated broadcast program becoming available at the associated distribution apparatus.

15. A wireless distribution apparatus for distributing a broadcast program around a building to an associated program receiving apparatus, comprising means (113) for receiving a request to transmit an indicated broadcast program, means (112) responsive to the received request for determining whether a current transmitted broadcast program is being transmitted to an associated program receiving apparatus, and means (112) responsive to determining that the current transmitted broadcast program is being transmitted to no associated program receiving apparatus for replacing (112) the current transmitted broadcast program by the indicated broadcast program.

16. A program receiving apparatus for receiving a broadcast program distributed around a building by an associated wireless distribution apparatus, comprising an interface (160b) for receiving an indication of a broadcast program to be received by the program receiving apparatus, a wireless receiver (162) for receiving the indicated broadcast program, and an adaptation means (162, 163) for adapting the program receiving apparatus to receive the indicated broadcast program from the associated distribution apparatus if the associated distribution apparatus has sufficient available transmission capacity to transmit the indicated broadcast program and otherwise adapting the program receiving apparatus to search for a non-associated distribution apparatus having available transmission capacity to transmit the indicated broadcast program.

17. A program receiving apparatus as claimed in claim 16, wherein the adaptation means (162, 163) for adapting the program receiving apparatus to receive the indicated broadcast program from the associated distribution apparatus comprises means (162, 163) for adapting the program receiving apparatus to receive a current transmission of the indicated broadcast program from the associated distribution apparatus.

18. A program receiving apparatus as claimed in claim 16, wherein the adaptation means (162, 163) for adapting the program receiving apparatus to receive the indicated broadcast program from the associated distribution apparatus comprises means (162, 163) for transmitting a request to the associated distribution apparatus for transmission of the indicated broadcast program.

19. A program receiving apparatus as claimed in claim 17, wherein the means (162, 163) for adapting the program receiving apparatus to search for a non-associated distribution apparatus having available transmission capacity to transmit the indicated broadcast program comprises means (162, 163) for searching for a non-associated distribution apparatus currently transmitting the indicated broadcast program.

20. A program receiving apparatus as claimed in claim 17, wherein the means for adapting the program receiving apparatus to search for a non-associated distribution apparatus having available transmission capacity to transmit the indicated broadcast program comprises means (162, 136) for requesting a non-associated distribution apparatus to transmit the indicated broadcast program.

21. A program receiving apparatus as claimed in claim 17, comprising means (162, 163) for, when receiving the indicated program from a non-associated distribution apparatus, intermittently checking the availability of transmission capacity of the associated distribution apparatus for transmitting the indicated program, and wherein the adaptation means for adapting the program receiving apparatus to receive the indicated broadcast program from the associated distribution apparatus is responsive to such capacity being available.
